(19) United States
(12) Patent Application Publication
(10) Pub. No.: US 2026/0063365 A1
(43) Pub. Date: Mar. 5, 2026

(54) SYSTEM AND METHOD FOR DRYING WET FEET AND BODY PARTS FROM BELOW

(71) Applicant: Charles B. Mathews, Gilbert, AZ (US)

(72) Inventor: Charles B. Mathews, Gilbert, AZ (US)

(21) Appl. No.: 18/901,197

(22) Filed: Sep. 30, 2024

Related U.S. Application Data
(60) Provisional application No. 63/688,832, filed on Aug. 29, 2024.

(51) Int. Cl. F26B 21/06

(52) U.S. Cl. CPC F26B 21/30

(57) ABSTRACT

The body drying apparatus can include a stand with an inner compartment and supports, a platform with slots for air flow, and an air blower with an air-outlet coupled to the stand. The platform, which can be made from moisture-absorbent diatomaceous earth, is supported by the stand and is in fluid communication with the air blower via a duct. The apparatus also includes a controller for the air blower, which may have variable speed and temperature control. The platform may include a binder such as cement, resin, or clay, and the stand may include structural reinforcement. The method for drying body parts involves standing on the platform and engaging the air blower, with the option to control the temperature and speed of the blower via a digital interface. The temperature of the heated air can be monitored and adjusted based on feedback from temperature sensors.

### CROSS REFERENCE TO RELATED APPLICATION

The present application claims the benefit under 35 U.S.C. 119 of U.S. Provisional Patent Application Ser. No. 63/688,832 filed Aug. 29, 2024. The U.S. Provisional Patent Application Ser. No. 63/688,832 is hereby incorporated by reference in its entirety.

### FIELD OF THE INVENTION

The present invention relates to the field of drying technology, specifically to systems and methods for drying wet body parts, with particular emphasis on applying drying mechanisms from below the body part, such as using heated air and moisture-absorbing materials.

### BACKGROUND OF THE INVENTION

Drying the human body after bathing or swimming can often be a time-consuming and inconvenient process. Traditional methods such as towel drying can be inefficient and may not fully remove moisture, leading to discomfort and potential skin issues. Furthermore, certain body parts, such as the feet, can be particularly difficult to dry thoroughly, creating a conducive environment for fungal infections. Existing technologies predominantly consist of conventional towels or foot mats to achieve drying. However, these methods are often ineffective, providing limited moisture absorption and requiring manual action that may prove inconvenient for users. For instance, towels must be frequently washed and dried, leading to additional inconvenience and resource consumption and if not washed provide an environment for bacteria to grow and spread to the user. Additionally, traditional foot mats often fail to provide thorough drying, leaving residual moisture on the mat that can result in discomfort or slippery surfaces, posing a safety risk.

Various automated drying systems, such as hand dryers adapted for foot drying, have been explored, yet present several limitations. These devices often struggle with inadequately channeling air to the foot's surface or providing uniform drying, which can lead to prolonged drying times and discomfort due to uneven heating. Furthermore, previous designs use holes in the pedestal where the user stands or a dip tray to catch all the water the user drips off their body creating a slippery surface.

Furthermore, some existing solutions employ high-porosity materials to absorb moisture but lack the integrated mechanisms for enhancing and accelerating the drying rate, particularly those targeting moisture evaporation from beneath the body. Integrating heated air mechanisms into such absorbing platforms presents a technical challenge, especially in achieving uniform heat distribution and airflow without compromising user safety and convenience. Additionally, safety is another concern in existing systems. High temperature blowers, if not properly monitored and controlled, can lead to burns or overheating. Insufficient safety mechanisms, such as the lack of temperature sensors and automated controls, can exacerbate these risks, making some systems unfit for unsupervised or residential usage.

What is needed is a drying system that addresses these inefficiencies by integrating a robust moisture-absorbing material with a facilitated airflow mechanism, which operates from below the moisture-absorbing surface. Such a system would employ a combination of moisture absorption and directional heated air to ensure thorough and efficient drying of wet body parts, particularly the feet. Enhanced safety features, including temperature control and variable speed adjustments, are also essential to provide consistent performance and user safety.

So as to reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art” and Applicant(s) expressly reserve(s) the right to swear behind any of the incorporated materials.

U.S. Patent App No. 20110079590

U.S. Patent App No. 20100313438

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### BRIEF SUMMARY OF THE INVENTION

The present invention relates to a body drying apparatus and method, specifically designed to efficiently dry the body of a user. The apparatus comprises a stand with a top and bottom section, an inner compartment, and supports. The stand supports a platform with a top, bottom, thickness, and one or more slots that allow air to flow through. The apparatus also includes at least one air blower coupled to the stand, with at least one air-outlet. A duct is provided, having a first end and a second end, with the first end coupled to the platform around the slots. The duct facilitates fluid communication between the blower and the slots. A controller can also be coupled to the air blower.

The platform can be manufactured from diatomaceous earth and is moisture absorbent. The apparatus may further comprise a filter between the air blower and the slots. The air blower may include variable speed and temperature control. The controller can have a digital interface that allows the user to control the air blower. The air blower may include temperature sensors that provide feedback to a controller to adjust the heating element and blower motor.

The platform can further comprise a binder selected from the group consisting of cement, resin, and clay. The binder can be mixed with diatomaceous earth in a ratio of 30-40% diatomaceous earth to 60-70% binder. The stand can comprise structural reinforcement selected from the group consisting of metal mesh, fiberglass strands, and natural fibers. The platform may include pore-forming agents to control porosity. The platform can be removable. The stand can further comprise reinforcement materials within the stand, selected from the group consisting of metal and plastics. The stand can be composed of cut stone.

The invention can also provide a method for drying body parts, which includes providing a slots in a panel of moisture absorbent material, providing a stand to support the panel, coupling a blower to the stand such that the blower is in fluid communication with the slots, and instructing a user to stand on the panel and engage the blower to dry the user's body. The method can further include allowing the user to control a temperature and speed of the blower via a digital interface, monitoring the temperature of heated air at multiple points and adjusting the temperature and speed of the hot air blower based on feedback from temperature sensors. The moisture-absorbing platform can be supported by a stand allowing air flow from below the platform through the slots. The moisture-absorbing platform may be processed by mixing diatomaceous earth with a binder selected from the group consisting of cement, resin, and clay. The binder may be mixed with diatomaceous earth in a ratio of 30-40% diatomaceous earth to 60-70% binder. The method may further comprise selecting a desired porosity and adding pore-forming agents to the moisture-absorbing platform to give the platform the desired porosity.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors'intent and desire that the simple, plain and ordinary meaning to the terms be applied to the interpretation of the specification and claims. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S. C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 shows an isometric view of a system and method for drying wet feet and body parts from below in accordance to one or more embodiments;

FIG. 2 shows a top view of the platform of a system and method for drying wet feet and body parts from below in accordance to one or more embodiments;

FIG. 3 shows a side view of a system and method for drying wet feet and body parts from below in accordance to one or more embodiments;

FIG. 4 shows a bottom view of a system and method for drying wet feet and body parts from below in accordance to one or more embodiments;

FIG. 5 an isometric view of the platform of a system and method for drying wet feet and body parts from below in accordance to one or more embodiments;

FIG. 6 shows a side view of another embodiment of a system and method for drying wet feet and body parts from below in accordance to one or more embodiments;

FIG. 7 shows a top view of another embodiment of a system and method for drying wet feet and body parts from below in accordance to one or more embodiments; and

FIG. 8 shows a bottom view of another embodiment of a system and method for drying wet feet and body parts from below in accordance to one or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

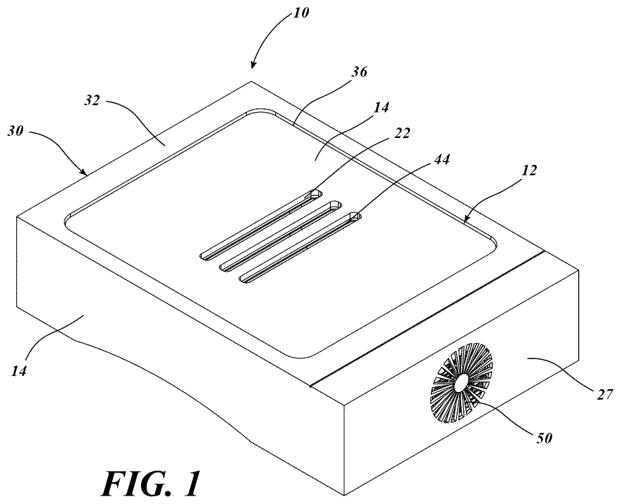

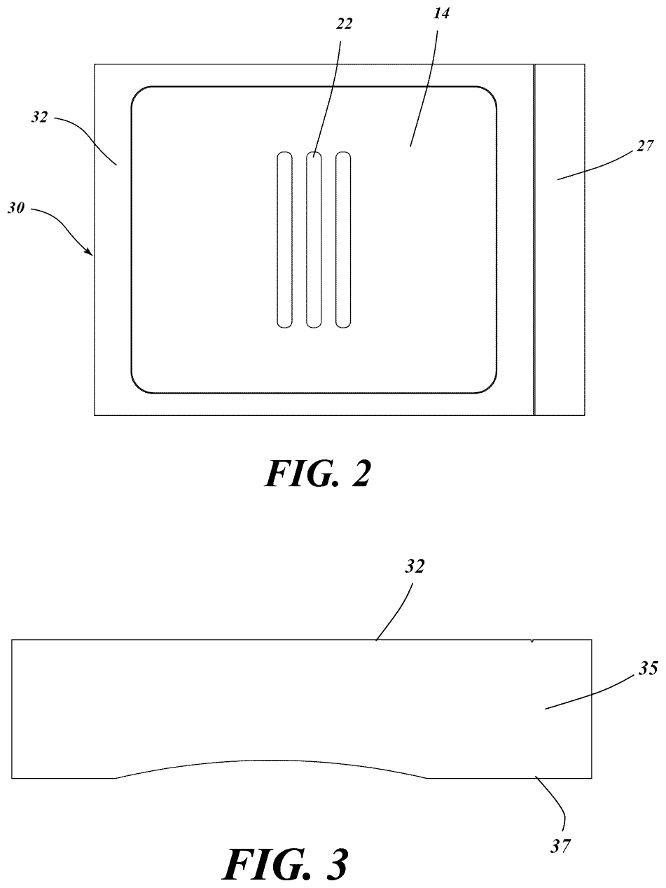

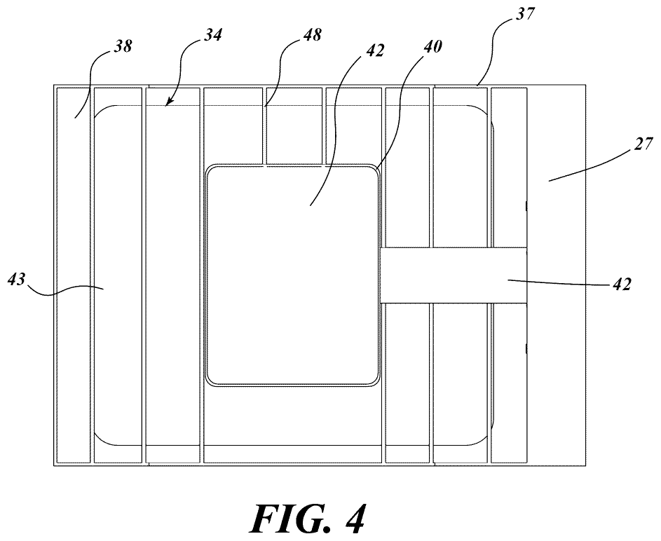

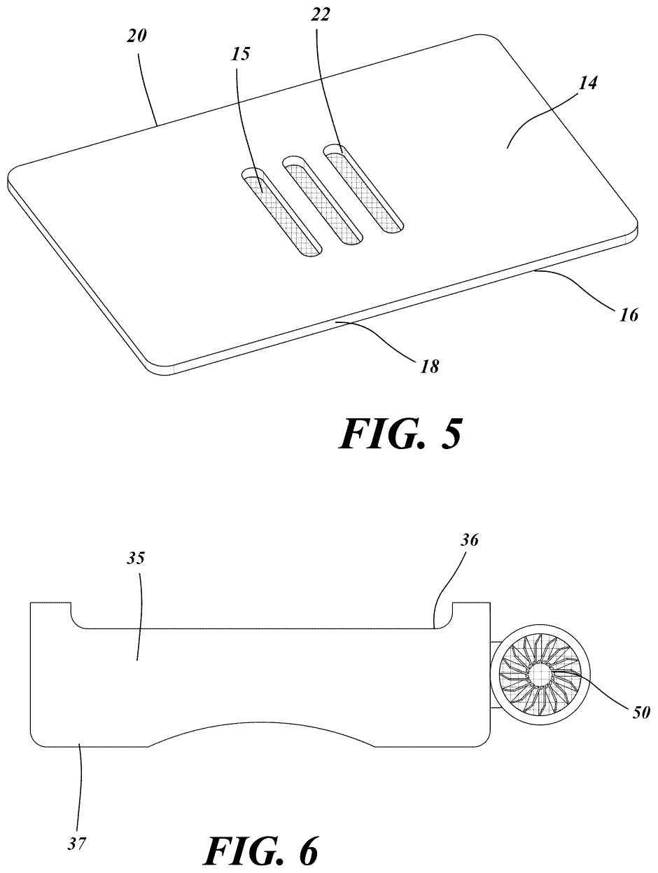

Referring initially to FIG. 1-8, a body drying apparatus is shown generally at 10. A body drying apparatus 10 can comprise a platform 12 removably coupled to a stand 30 wherein the platform can have a top 14 and a bottom 16 with a thickness 18 and length 20. The platform 12 can be any suitable shape and size, but in the preferred embodiment the platform can sized to fit within the stand 30 and create a platform for an individual to stand on. The platform 12 can be made from moisture-absorbing material such as, for example, diatomaceous earth, silica gel, activated charcoal, calcium chloride, vermiculite, magnesium sulfate, or the like. The platform 12 moisture-absorbing material can be made by mixing diatomaceous earth with a binder selected from the group consisting of cement, resin, and/or clay. The binder can be mixed with diatomaceous earth in a ratio of 20-50% diatomaceous earth to 50-80% binder.

The platform 12 can comprise pore-forming agents to control porosity and a surface finish to enhance user comfort while retaining porous qualities. In certain embodiments, the platform 12 can have drainage through the porous material directing the water from the user to one side or the other to be collected and evaporated. The platform 12 can have a one or more slots 22 extending from the center of the platform towards the outer edges of the platform. The slots 22 can be any suitable shape or size, such as, for example, rectangular, square, circular, polygonal, or the like and in the preferred embodiment the slots are rectangular with radius corners. The slots 22 can be angled or can be straight directing the air flow toward the individual. The slots 22 can be evenly or unevenly spaced on the platform 12. In certain embodiments the slots 22 have a filter on their top or bottom side allowing for air flow, but catching anything that tries to fall through the slots. The slots 22 can be plurality of holes spaced evenly or unevenly over the top side of the platform 12 and the stand 30.

In embodiments, the stand 30 can comprise a top section 32, a bottom section 34 and a side wall 35 extending from the top section forming an inner compartment 38 wherein the top section can have a recess 36 for the platform 12 to be removably coupled to. The bottom section 34 can have an inner surface 43 wherein an duct connection 40 can extend from wherein the tube connection can have a thickness allowing an duct 42 to be coupled to it by such as, for example, press fit, clamped, retaining ring, fasteners, adhesive, or the like. The duct 42 can have a first end and a second end wherein the first end can be coupled to the air duct connection 40 and the second end is coupled to the stand and/or blower wherein the duct can provide fluid communication between a blower 50 and the slots 22. The air duct connection 40 and the air duct 42 can have a seal between to the two allowing the connection to be airtight. In certain embodiments, the air duct 42 can have a backdraft damper to help prevent reversal of airflow when the blower is off.

In embodiments, the air duct connection 40 can allow the user to removable replace the air duct or a filter that can be placed between the duct 42 and the inner surface 43 within the air duct connection 40. The side wall 35 can have a stand bottom 37 wherein the stand bottom can support the stand 30 and can have anti-slip tabs coupled to it wherein the anti-slip tabs can be such as, for example, rubber, silicone, cork, felt, plastic, foam or the like. The side walls 35 can be angled or straight up and down from the top section.

In embodiments, the stand 30 can have one or more stand slots 44 that correspond with the platform 12 one or more platform slots 22. The one or more stand slots 44 can be within the air duct connection 40 allowing for the air to flow through the stand slots 44 and the platforms slots 22. In certain embodiments, the one or more stand slots 44 can have a directional flap on the slots allowing the user to set the direction of air flow either manually with an air flow slide or automatically through a motor and a controller wherein allowing the user to move the air back and forth while drying. The air flow slide or the motor can be coupled to the directional flaps.

In embodiments, the stand 30 can have a plurality of supports or structural reinforcements 48 wherein the supports can be coupled or formed into the stand and can extend from the inner surface 43 to the bottom of the stand. The supports 48 can be an array of ribs evenly or unevenly distributed throughout the inner compartment to add structural support and rigidity to the platform. In certain embodiments, the supports 48 can be omitted and the inner surface 43 can extend to the ground supporting the platform 12. The stand 30 and the supports 48 can be made from such as, for example, metal, plastic, ceramics, composite, metal mesh, fiberglass strands, or the like.

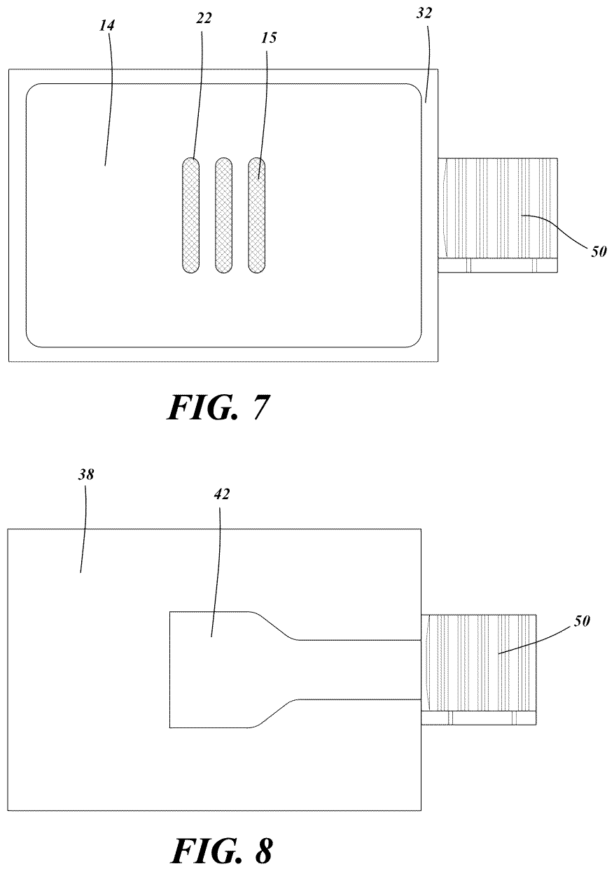

The body drying apparatus 10 can further comprise at least one air blower 50 which can be coupled to the stand 30 and the duct 42. The air blower 50 can blow hot or cold air through the air duct 42 through the slots 22. The air blower 50 can be such as, for example, forced air blower, electric blower, heat guns, infrared blower, or the like and can blow both hot and cold air at user specified temperatures. The air blower 50 can be configured to direct heated air beneath the moisture-absorbing platform 12. The air blower 50 can comprise a variable speed and temperature control, which can include a digital interface or a mobile application interface. The blower 50 can be connected to a controller which can be a micro-controller, or any equivalent controller having at least one wireless connection, and at least one temperature sensor that can provide feedback to the controller which can allow the controller or the user to adjust the heating element and speed of the blower motor. The air blower 50 can be either inside a blower compartment as shown in FIG. 1 or can be outside of the stand as shown in FIG. 7. The blower compartment 27 can be removably coupled, permanently coupled, or formed as one piece with the stand 30. The blower compartment 27 can have at least one air duct connection 40 wherein the blower can be coupled to the air duct connection 40 extending from the side wall 35. The air blower 50 can be sealed to the side wall 35 or the air duct connection 40 directing air from the blow through the at least one slots 22, 44.

The controller can allow the user to set a specific heat or speed of the blower 50. The controller can be within the inner compartment, in the blower compartment, or on the air blower 50. The sensors can be such as, for example, temperature, humidity, pressure or the like wherein in certain embodiments the pressure sensor can detect when the user is standing on the platform 12 activating the air blower 50 and recognize when the user steps of the platform turning off the air blower. The temperature sensors can detect if the air becomes too hot and either shut down the air blower or turn off the heating elements within the air blower.

In other embodiments the stand 30 can have a drying duct within the walls of the recess and the air duct can have a flow direction control that can direct the flow to the drying duct allowing the user to dry the platform 12 after use. The drying duct can open and close by at least one drying duct motor or manually by the user when not in use. The controller can be coupled to a digital or analog screen which can be coupled to the stand 30 or the air blower 50 wherein the screen can allow the user to see and set the temperature, blower speed, platform drying, or the like.

In embodiments, a method for drying body parts which can comprise placing a wet body on the moisture-absorbing platform, absorbing moisture from the wet body part through the moisture-absorbing platform, directing heated air from the hot air blower through the duct to the moisture-absorbing platform, and passing the heated air through the slots within the moisture-absorbing platform to assist in drying the wet body part. The user can direct the air back and forth and leave it coming straight through the slots.

The method for drying body parts can comprise providing a slot which can be vent in a panel of moisture absorbent material, providing a stand to support the panel, coupling a blower to the stand such that the blower is in fluid communication with the slot, and instructing a user to stand on the panel and engage the blower to dry the user's body.

The method may further comprise allowing the user to control a temperature and speed of the blower via a digital interface, monitoring the temperature of heated air at multiple points and adjusting the temperature and speed of the hot air blower based on feedback from temperature sensors. The moisture-absorbing platform can be supported by a stand allowing air flow from below the platform through the slots. The moisture-absorbing platform can be processed by mixing diatomaceous earth with a binder selected from the group consisting of cement, resin, and clay. The binder may be mixed with diatomaceous earth in a ratio of 30-40% diatomaceous earth to 60-70% binder. The method can further comprise selecting a desired porosity and adding pore-forming agents to the moisture-absorbing platform to give the platform the desired porosity.

The inventive concept, although presented with reference to the particularly described embodiments and descriptions, is not limited to these descriptions and the accompanying drawings. On the contrary, persons skilled in the art will recognize the possibility of various modifications and enhancements. Nevertheless, such modifications or enhancements, if applied or utilized, will not be a departure from the scope, spirit, and intent of the present inventive concept as set forth in the claims herein.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

I claim:

1. A body drying apparatus comprising:
a stand having a top section and a bottom section with a thickness having an inner compartment and supports;
a platform having a top and a bottom and is supported by the top section of the stand, the platform comprising a thickness and one or more slots allowing air to flow through the platform;
at least one air blower coupled to the stand wherein the at least one air blower has at least one air-outlet;
a duct having a first end and a second end wherein the first end is coupled to the platform about the slots and wherein the duct provides fluid communication between the blower and the slots; and
a controller coupled to the air blower.

2. The body drying apparatus of claim 1, wherein the platform is manufactured from diatomaceous earth and is moisture absorbent.

3. The body drying apparatus of claim 1, further comprising a filter between the air blower and the plurality of slots.

4. The body drying apparatus of claim 1, wherein the air blower comprises at least one of variable speed and temperature control.

5. The body drying apparatus of claim 4, wherein the controller has a digital interface that allows the user to control the air blower.

6. The body drying apparatus of claim 4, wherein the air blower includes temperature sensors that provide feedback to a controller to adjust the heating element and blower motor.

7. The body drying apparatus of claim 2, wherein the platform further comprises a binder selected from the group consisting of cement, resin, and clay.

8. The body drying apparatus of claim 7 wherein the binder is mixed with diatomaceous earth in a ratio of 30-40% diatomaceous earth to 60-70% binder.

9. The body drying apparatus of claim 1 wherein the stand comprises structural reinforcement selected from the group consisting of metal mesh, fiberglass strands, and natural fibers.

10. The body drying apparatus of claim 1 wherein the platform includes pore-forming agents to control porosity.

11. The body drying apparatus of claim 1, wherein the platform is removable.

12. The body drying apparatus of claim 1, further comprising reinforcement materials within the stand, selected from the group consisting of metal and plastics.

13. The body drying apparatus of claim 1, wherein the stand is composed of cut stone.

14. A method for drying body parts, comprising:
providing a slots in a panel of moisture absorbent material;
providing a stand to support the panel;
coupling a blower the stand such that the blower is in fluid communication with the slots;
instructing a user to stand on the panel and engage the blower to dry the user's body.

15. The method of claim 14 further comprising allowing the user to control a temperature and speed of the blower via a digital interface.

16. The method of claim 15 further comprising monitoring the temperature of heated air at multiple points and adjusting the temperature and speed of the hot air blower based on feedback from temperature sensors.

17. The method of claim 14 wherein the moisture-absorbing platform is supported by a stand allowing air flow from below the platform through the slots.

18. The method of claim 14 wherein the moisture-absorbing platform is processed by mixing diatomaceous earth with a binder selected from the group consisting of cement, resin, and clay.

19. The method of claim 18 wherein the binder is mixed with diatomaceous earth in a ratio of 30-40% diatomaceous earth to 60-70% binder.

20. The method of claim 14 further comprising selecting a desired porosity and adding pore-forming agents to the moisture-absorbing platform to give the platform the desired porosity.
